(19) United States
(12) Patent Application Publication
(10) Pub. No.: US 2010/0217751 A1
(43) Pub. Date: Aug. 26, 2010

(54) METHOD AND SYSTEM FOR SAFELY DELETING INFORMATION FROM A COMPUTER

(75) Inventor: Andrei Ciubotaru, Lasi (RO)

Correspondence Address: Richard Rowley;Suite 1400, 525 Washington Blvd., Jersey City, NJ, 07310, US

(73) Assignee: Comodo Security Solutions, Inc.

(21) Appl. No.: 12/696,391

(22) Filed: Jan. 29, 2010

Related U.S. Application Data
(60) Provisional application No. 61/155,194, filed on Feb. 25, 2009.

(51) Int. Cl. G06F 17/30

(52) U.S. Cl. 707/650; 707/692; 707/E17.007; 707/E17.01

(57) ABSTRACT

The present invention comprises a method and system for safely deleting files and registry keys from the operating system. The process works by having a file system filter or registry monitor intercept commands to delete information. Instead of deleting the file or registry key, the system monitor places the information in a list of blocked files, making the file and key inaccessible to all other programs. If the machine later experiences errors, access to the file can be restored. If the machine is unaffected by the apparent deletion of the file, then the file is permanently deleted.

### CROSS-REFERENCE TO RELATED APPLICATION

This application claims the benefit of provisional application Ser. No. 61/155,194, filed Feb. 25, 2009, which is incorporated entirely herein by reference.

### BACKGROUND

Users will often want to delete files from their computer to save space or improve performance. However, deleting files and registry entries can be risky. Deleting important system files or registry entries causes problems with the operating system or installed programs. Often users accidentally delete a file only to find out later that the file was vital to their computer's normal operating condition, leading to long support hours and high cost repairs.

Thus, users need a way to safely delete files from their computer and restore their computer's operation if a critical file is accidentally deleted.

### SUMMARY

The disclosed invention is a method and system of safely deleting files and registry entries. The invention works by intercepting commands for file deletion. Instead of deleting the file, the file is listed in a database as a deleted file and is hidden from the user and other applications on the computer. Other applications cannot access the deleted file. If something goes wrong with a program or the operating system, access to the file can be restored, returning the computer to full operating condition.

File interception occurs using a file system filter (FS Filter) that monitors calls from the user. The FS Filter intercepts the command and overrides the delete command.

### BRIEF DESCRIPTION OF THE FIGURES

FIG. 1 is a flowchart of an embodiment of the invention.

FIG. 2 is representation of the elements of the first embodiment.

FIG. 3 is a flowchart of a how the invention works on restart.

FIG. 4 is a flowchart of the response taken to a critical error.

FIG. 5 is a flowchart of a different embodiment on how the invention can respond to a critical error.

FIG. 6 is a flowchart of an example related to accidental deletion of email files.

FIG. 7 is a depiction of the example described in FIG. 6.

FIG. 8 is a representation of the continuous cycle of the invention.

FIG. 9 is a flowchart of how the invention can be applied to protect the registry.

### DETAILED DESCRIPTION

As used herein, a file system filter (FS Filter) is either an application or API that overlays the file system and intercepts messages sent to the file system, typically from a user. Typically, an FS Filter is a driver used solely to intercept messages and is accessed when a separate application utilizes the API functions. However, the FS Filter and application could be a single piece of software running on the machine. Anytime, this invention refers to the FS Filter, it is understood that FS Filter could refer to a separate application with an accompanying FS Filter driver, one or more applications running on the machine utilizing the FS Filter driver of an operating system, or a single application the has an file system filter driver built in. The FS Filter can also apply to the registry and intercept messages sent to modify, add, or delete registry keys. This allows the invention to both protect the core files on the computer along with the information stored by the registry.

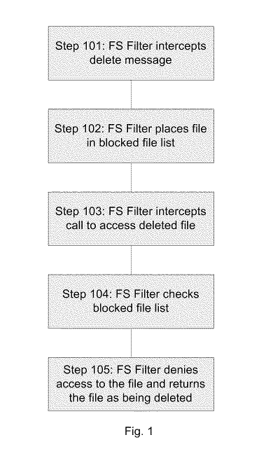

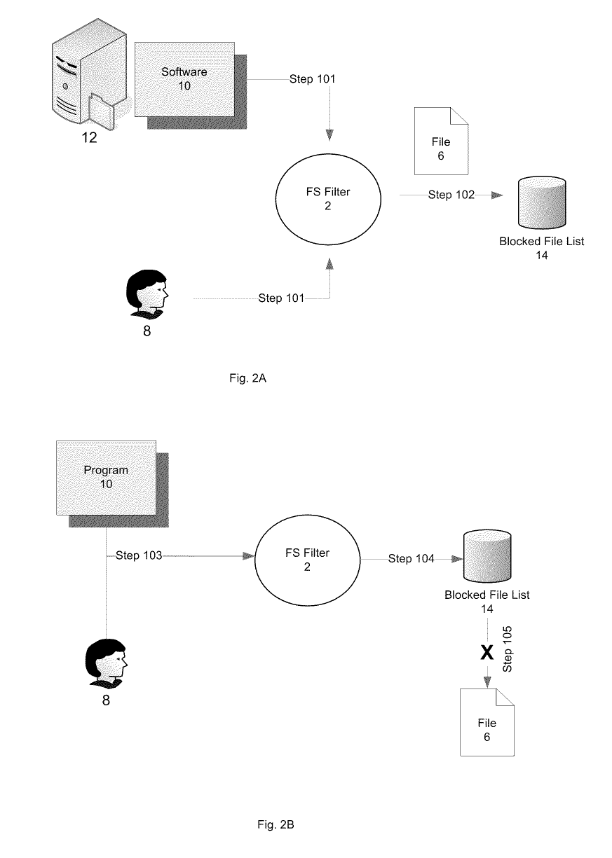

In step 101 of FIG. 1 and FIG. 2, the FS Filter 2 intercepts a command to delete a file 6. The command can be sent from the user 8 or software 10 running on the machine 12 or on a server, such as security software. The command from security software might be in response to a possible virus being detected on the system protected by the invention. In step 102, instead of deleting the file 6, the FS Filter 2 (or an application interacting with the FS Filter) makes the selected file 6 inaccessible. The file 6 appears deleted to the user 8 and other software 10 running on the machine 12 but remains on the harddrive of the machine. A machine could be a computer, server, PDA, phone, or other electronic device where files could be deleted. A file can be a registry entry, database, executable, document, DLL, or other location where information or code is stored on the machine.

The file 6 is made inaccessible by listing the file 6 in a blocked file list 14. In Step 103, when a separate program 14 (including the operating system) or when the user 8 tries to access the file 6, the FS Filter 2 intercepts the access command and checks to see if the file is part of the blocked file list 14. If the file 7 is found on the blocked file list 14, then the FS Filter 2 blocks access to the file 6, making the file appear to be completely removed. To ensure that the user is not confused about whether a file is deleted or not, on start up of the machine 12, the operating system or other software running on the machine reads the contents of the blocked file list 14 into memory and hides each file listed on the blocked file list 14 from the user 8.

The FS Filter 2 blocks access to files in the blocked file list 14 by monitoring each request made for a file. If the requested file is found in the blocked file list 14, the FS Filter 2 returns a message that the file has been deleted or is missing. If the file is not found in the blocked file list 14, the FS Filter 2 allows the request to proceed and the file is processed in the typical manner. The FS Filter can keep the blocked file list in memory or can check the blocked file list using standard database lookup routines each time a file is accessed.

If problems occurs after the file 6 is deleted, the deleted file 6 can be restored to its original state. The deleted file 6 can be restored manually by the user 8 by asking the user to select files in the blocked file list 14 to restore.

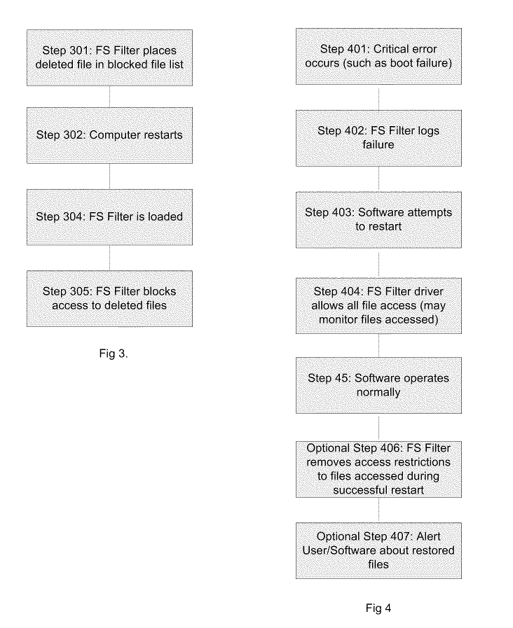

Alternatively, as shown in FIG. 4, the FS Filter 2 can monitor which files are accessed during the machine's 12 operation or boot up process. In step 402, the failure is logged by the FS Filter 2. The software experiencing the critical failure (such as the operating system during boot up) restarts. The FS Filter 2 checks its logs and notes that a critical failure occurred with the restarted software. In step 404, during the restart, the FS Filter 2 allows complete access to the files in the blocked file list 14. While the software restarts, the FS Filter 2 monitors which files are accessed that are also listed on the blocked file list 14. Optionally in step 406, once the software successfully restarts into a normal operating condition, the FS Filter 2 removes the files accessed during the restart from the blocked file list 14.

Alternatively, if the machine 12 fails to start or if a critical event is logged on the machine, then the FS Filter 2 can determine which file in the file blocked list 14 was the last file accessed or that resulted in an error. The FS Filter 2 then restores the file that was last accessed to full functionality by removing the deleted file from the blocked file list 14, allowing the file 6 to be accessed by the user 8. The user 8 is warned that the deleted file 6 was restored to the machine 12 because of an error in the machine's operation. The user 8 can then take the appropriate actions to resolve the problem.

What constitutes a critical error can vary between separate embodiments of the invention. For example, a critical operating system error might cause the machine to reboot, whereas a critical error in software might prevent the software from operating as requested by a user. The FS Filter can include a definition of what constitutes a critical error for each application or can have a general definition such as an application failing to start properly. Critical errors can also be limited to only those errors causing the machine to not operate in its intended manner. The critical error definition can be set by the user using the FS Filter, by the FS Filter developer, or defined upon installation of the FS Filter using a wizard to configure the FS Filter's functions based on user preference.

Alternatively, instead of only restoring the blocked file that was last accessed, the FS Filter 2 can restore any combination of (i) all files accessed from a certain time before when the critical error occurred, (ii) all files that were added to the blocked file list 14 since the last successful start of the application creating the error, (iii) all files that were added to the blocked file list 14 since a certain time or date, (iv) all files that were added to the blocked file list 14 since the machine 12 was restarted, and (v) all files in the blocked file list 14. Restoring multiple files simultaneously, instead of restarting the application after each unsuccessful attempt to run the application, lowers the number of critical errors occurring on the machine. In each case, the FS Filter 2 alerts the user 8 or security software 10 protecting the machine 12 about which files were restored to correct the critical error. If security software 10 is alerted about restored files, the security software 10 can run the restored files in a limited capacity to ensure they do not include malware.

To increase space, the deletion process can be finalized, removing the files from the blocked file list. Final deletion occurs after the FS Filter 2 receives a request from a user 8 that the files be permanently deleted. Alternatively, the final deletion occurs after a certain amount of time passes without a critical error being generated. For example, if the machine reboots and the operating system restarts successfully then the file 6 would be actually deleted from the machine's hard drive.

A separate embodiment is shown in FIG. 5. In step 501, the user 8 deletes a file 6 that happens to be a system file. In step 502, the file 6 is placed in the blocked file list 14. In step 503, the deleted file causes the operating system to fail. This failure is logged by the FS Filter 2. In steps 504, the machine 12 restarts and determines that the previous restart failed to complete successfully. In step 505, the machine 12 attempts to restart again allowing access to the just deleted file 6. In step 506, the operating system again fails, and the machine restarts. The FS Filter 2 then allows access to even more files. This process is repeated as many times as necessary until the machine is operational again.

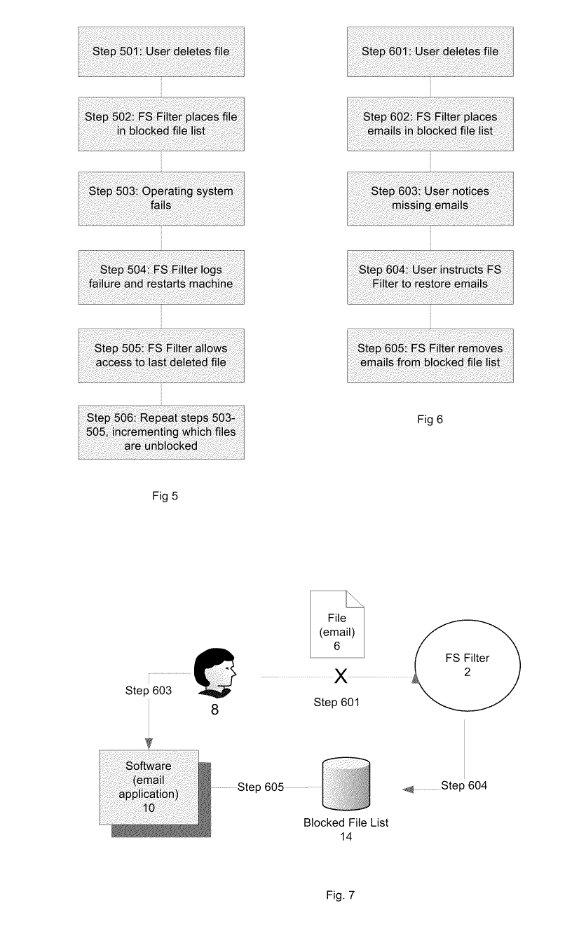

In an alternate embodiment, depicted in a FIGS. 6 and 7, a user 8 deletes his email inbox. In step 602, the FS Filter 2 places the file 6 in the blocked file list 14, and the FS Filter 2 denies access to the deleted file 6. In step 603, when the user 8 tries to open his email, any of the following might occur: the user notices the missing emails, receives an error from the email application about the missing item, or the application crashes. In step 604, the user 8 realizes the mistake and instructs the FS Filter 2 to remove the file 6 from the blocked file list 14. The FS Filter 2 removes the access restrictions, allowing the user to operate their email application in the same state as before the deletion.

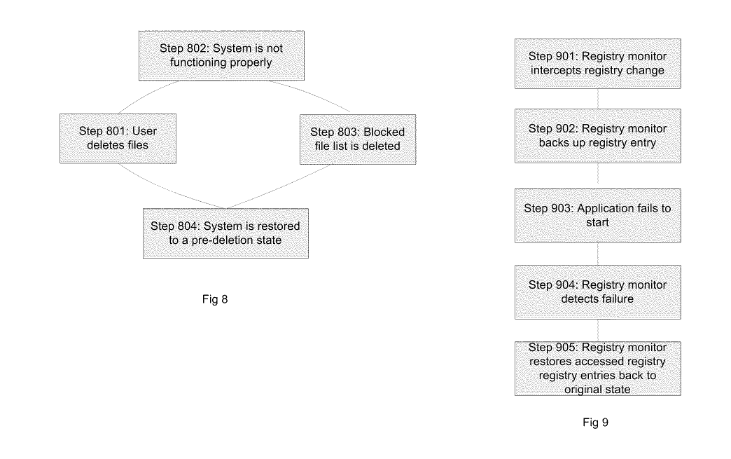

In an alternate embodiment, shown in FIG. 8, the entire list of files that are being blocked is cleared or deleted when an error is encountered, allowing the system to quickly be restored to a pre-deletion state.

For registry protection, the registry monitor (which is the same as the FS Filter but acts on the registry) logs deletions and modifications made to registry. The registry monitor also monitors calls to registry keys that have been deleted or modified. If an application fails to start after calling a changed registry key or if the machine stops functioning or cannot boot during a restart, the registry monitor restores the deleted or modigied registry entry. Registry restoration functions the same way as other file restoration and can be done atomically by the registry monitor or manually by the user.

In step 901 of FIG. 9, a registry entry is deleted. In step 902, the FS Filter (also called the Registry Monitor as it is monitoring calls and changes to the registry rather than files) backs up the registry entry either upon startup, at the user's request, or prior to intercepting the delete command. From this point forward, the process is the same as for file deletion. In step 903, an application relying on the registry key fails to start or functions improperly. In step 904, the Registry Monitor detects the failure and, in step 905, restores the changed registry file. Alternatively, if an error occurs, all of the changes to the registry are removed upon the first crash to minimize the number of potential restarts of the application.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of protecting a machine comprising:
a. intercepting an instruction to delete a file on a machine;
b. making the file inaccessible instead of deleting the file, and
c. taking an action based on how making the file inaccessible affects the operations of the machine.

2. A method according to claim 1, where the action taken comprises deleting the file.

3. A method according to claim 1, where the intercepting an instruction comprises an application accessing a file driver using an API function.

4. A method according to claim 1, where making the file inaccessible comprises listing the file in a database of blocked list.

5. A method according to claim 4, making the file inaccessible comprises preventing access to any files included in a database of blocked files.

6. A method according to claim 1, where the action taken comprises restoring the accessibility of the file.

7. A method according to claim 6, where the accessibility of the file is restored after a critical error occurs on the machine.

8. A method according to claim 6, where the action taken comprises restoring access to all files listed in a database of blocked files.

9. A method according to claim 6, where the file is restored after the machine restarts.

10. A method according to claim 6, where the file is restored after successive failures to restart the machine.

11. A method according to claim 1 where the instruction comprises a request from a user to delete the file.

12. A method according to claim 1, where the action taken comprises:
a. determining whether the file is necessary for the standard operation of the machine, and
b. making the file accessible if the file is necessary for the standard operation of the machine.

13. A method of protecting a registry entry comprising:
a. creating a backup of the registry entry,
b. taking an action on a registry entry,
c. observing the operation of the computer, and
d. restoring the registry entry based on the computer's operation after the action takes effect.

14. A method according to claim 13, where the action taken comprises deleting a registry key.

15. A method according to claim 13, where the action taken comprises modifying a registry key.

16. A method according to claim 13, where restoring the registry entry comprises restoring the registry entry after a critical error occurs on the machine.

17. A method according to claim 13, where restoring the registry entry comprises restoring all registry entries listed in a database of registry entries.

18. A method according to claim 13, where restoring the registry entry occurs when the machine restarts.

19. A method according to claim 13, where the registry entry is restored after successive failures to restart the machine.

20. A system of protecting a machine comprising
a. A machine,
b. An operating system,
c. A file system filter,
d. Means of deleting a file, and
e. Means of restoring the deleted file if the file is necessary for the operation of the machine.

21. A method according to claim 20, where deleted file is restored after a critical error occurs on the machine.

22. A method according to claim 20, where the file is deleted by other software running on the machine.

23. A method according to claim 20, where restoring the deleted file comprises restoring all files listed in a database of deleted files.
